(19) United States
(12) Patent Application Publication
(10) Pub. No.: US 2026/0125568 A1
(43) Pub. Date: May 7, 2026

(54) WATER-BASED INK FOR NON-PERMEABLE MEDIA

(71) Applicant: KYOCERA DOCUMENT SOLUTIONS INC., OSAKA-SHI (JP)

(72) Inventor: YASUKO TAKAORI, OSAKA-SHI (JP)

(21) Appl. No.: 19/377,046

(22) Filed: Nov. 3, 2025

(30) Foreign Application Priority Data
Nov. 6, 2024 (JP) 2024-194306

(51) Int. Cl. C09D 11/30; C09D 11/033; C09D 11/102

(52) U.S. Cl. CPC C09D 11/30; C09D 11/033; C09D 11/102

(57) ABSTRACT

A water-based ink for non-permeable media includes: a pigment, a urethane resin, a polyethylene wax, triethylene glycol monobutyl ether, and water. The urethane resin has a glass transition temperature of 40° C. or more and 110° C. or less and a breaking elongation at 25° C. of 50% or less. The polyethylene wax has a melting point of 100° C. or more and 140° C. or less. The content of the urethane resin is 3 mass % or more and 8 mass % or less in terms of solid content. The content of the polyethylene wax is 2 mass % or more and 5 mass % or less in terms of solid content. The content of the triethylene glycol monobutyl ether is 3 mass % or more and 6 mass % or less.

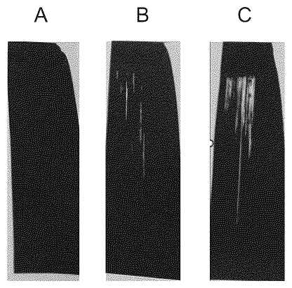

### CROSS-REFERENCE TO RELATED PATENT APPLICATION

This application claims the benefit of Japanese Priority Patent Application JP 2024-194306 filed on Nov. 6, 2024, the entire contents of which are incorporated herein by reference.

### FIELD OF THE DISCLOSURE

The present disclosure relates to a water-based ink for non-permeable media.

### BACKGROUND OF THE DISCLOSURE

Japanese Patent Application Laid-open No. 2022-053691 discloses a water-based ink for forming an image on media using an inkjet recording apparatus. Such a water-based ink has to have high adhesion to non-permeable media having low water permeability when forming an image on the non-permeable media. Meanwhile, in the water-based ink disclosed in Japanese Patent Application Laid-open No. 2022-053691, a polyolefin resin is blended as a binder in order to achieve high adhesion to the non-permeable media.

### SUMMARY OF THE DISCLOSURE

According to an embodiment of the present disclosure, there is provided a water-based ink for non-permeable media, including: a pigment; a urethane resin; a polyethylene wax; triethylene glycol monobutyl ether; and water.

The urethane resin has a glass transition temperature of 40° C. or more and 110° C. or less and a breaking elongation at 25° C. of 50% or less.

The polyethylene wax has a melting point of 100° C. or more and 140° C. or less.

The content of the urethane resin is 3 mass % or more and 8 mass % or less in terms of solid content.

The content of the polyethylene wax is 2 mass % or more and 5 mass % or less in terms of solid content.

The content of the triethylene glycol monobutyl ether is 3 mass % or more and 6 mass % or less.

### BRIEF DESCRIPTION OF THE DRAWINGS

The FIGURE is a diagram showing evaluation criteria for rubfastness in Examples and Comparative Examples.

### DETAILED DESCRIPTION OF THE EXEMPLARY EMBODIMENTS

In the water-based ink disclosed in Japanese Patent Application Laid-open No. 2022-053691, the polyolefin resin that is the main component has a low hardness, making it difficult to achieve sufficient rubfastness in images formed on non-permeable media. Further, water-based inks in which a binder is blended have a problem that it is difficult to achieve ejection stability.

In view of the circumstances as described above, it is an object of the present disclosure to provide a water-based ink capable of forming an image with high adhesion and rubfastness on non-permeable media while ensuring ejection stability.

An embodiment of the present disclosure will be described.

### [Overall Configuration]

A water-based ink for non-permeable media according to this embodiment (hereinafter, also referred to simply as an “ink”) includes a pigment a, a urethane resin b, a polyethylene wax c, triethylene glycol monobutyl ether d, and water. A recording medium on which an image is to be formed with the ink according to this embodiment is a non-permeable medium having low ink permeability.

The urethane resin b blended in the ink according to this embodiment has a glass transition temperature of 40° C. or more and 110° C. or less and a breaking elongation at 25° C. of 50% or less, and exhibits relatively hard properties. In the ink according to this embodiment, by using the hard urethane resin b, high rubfastness and high ejection stability can be achieved. Further, in the ink according to this embodiment, by blending the triethylene glycol monobutyl ether d, after impacting on the non-permeable medium, the molecular chain of the urethane resin b can be sufficiently extended, allowing the urethane resin b to have a uniform film shape. As a result, in the ink according to this embodiment, the effect of improving adhesion and rubfastness by the urethane resin b can be obtained uniformly along the in-plane direction.

In the ink according to this embodiment, by using the hard urethane resin b, the rubfastness and ejection stability are improved, but the inherent effect of improving adhesion by the urethane resin b is made difficult to achieve. In the ink according to this embodiment, the polyethylene wax c having a composition similar to that of the material of the non-permeable media is blended to compensate for this decrease in adhesion. The polyethylene wax c blended in the ink according to this embodiment has a melting point of 100° C. or more and 140° C. or less, and exhibits relatively hard properties. In the ink according to this embodiment, by using the polyethylene wax c that is relatively hard similar to the urethane resin b, the compatibility between the urethane resin b and the polyethylene wax c is improved, thereby further enhancing the adhesion to non-permeable media.

As described above, the ink according to this embodiment is configured to be capable of forming an image with both adhesion and rubfastness on non-permeable media. For this reason, even in the case where the ink according to this embodiment is used to form an image on the front surface exposed to the viewer of the non-permeable medium, e.g., surface printing on transparent non-permeable media, the configuration capable of forming images with both adhesion and rubfastness allows the images to be less likely to peel or rub off without additional treatment such as lamination for protecting the images. Therefore, the ink according to this embodiment is particularly suitable for preparing a printed matter in which the recording surface of the non-permeable medium is viewed facing up and no treatment for protecting the image is applied. However, the ink according to this embodiment is not limited to the above applications, and may be used for, for example, back printing on transparent non-permeable media.

### [Detailed Configuration]

### (Pigment a)

The ink according to this embodiment includes the pigment a as a coloring agent from the viewpoints of color mixing prevention and improvement in water resistance in images recorded on the recording medium. The pigment a may be either an inorganic pigment or an organic pigment. Further, as the pigment a, these may be combined with an extender pigment as necessary.

Specific examples of the inorganic pigment that can be used in the ink according to this embodiment include carbon black and a metal oxide. In particular, in the case of a black ink, carbon black is favorable. Examples of the carbon black include furnace black, thermal lamp black, acetylene black, and channel black.

Specific examples of the organic pigment that can be used in the ink according to this embodiment include an azo pigment, a diazo pigment, a phthalocyanine pigment, a quinacridone pigment, an isoindolinone pigment, a dioxazine pigment, a perylene pigment, a perinone pigment, a thioindigo pigment, an anthraquinone pigment, and a quinophthalone pigment.

In the ink according to this embodiment, the hue is not particularly limited, and a colored pigment of any of colors such as yellow, magenta, cyan, blue, red, orange, and green can be used. Favorable specific examples of the colored pigment include C.I. Pigment Yellow, C.I. Pigment Red, C.I. Pigment Orange, C.I. Pigment Violet, C.I. Pigment Blue, and C.I. Pigment Green. The ink according to this embodiment can use one or two or more selected from these colored pigments as the pigment a.

### (Urethane Resin b)

In the ink according to this embodiment, the urethane resin b is blended as a binder. The urethane resin b is fine particles formed of polyurethane. In the ink according to this embodiment, the content of the urethane resin b is 3 mass % or more in terms of solid content in order to sufficiently achieve the above effect of the urethane resin b. Further, in the ink according to this embodiment, the content of the urethane resin b is 8 mass % or less in terms of solid content in order to avoid ejection failure due to contamination or thickening of the nozzle surface in the recording head. Further, in the ink according to this embodiment, the urethane resin b favorably has a particle size (D50) of 10 nm or more and 100 nm or less in order to more effectively achieve the above effect of the urethane resin b.

### (Polyethylene Wax c)

In the ink according to this embodiment, the polyethylene wax c is blended as a binder. The polyethylene wax c is fine particles formed of polyethylene having a low molecular weight. In the ink according to this embodiment, the content of the polyethylene wax c is 2 mass % or more in terms of solid content in order to sufficiently achieve the above effect of the polyethylene wax c. Further, in the ink according to this embodiment, the content of the polyethylene wax c is 5 mass % or less in terms of solid content in order to avoid ejection failure due to contamination or thickening of the nozzle surface in the recording head.

### (Triethylene Glycol Monobutyl Ether d)

In the ink according to this embodiment, the triethylene glycol monobutyl ether d is blended as a film-forming aid. The triethylene glycol monobutyl ether d is a water-soluble organic solvent with high safety, and exhibits properties with excellent compatibility with the urethane resin b (an SP value, a boiling point, etc.). In the ink according to this embodiment, the content of the triethylene glycol monobutyl ether d is 3 mass % or more in order to sufficiently achieve the above effect of the triethylene glycol monobutyl ether d. Further, in the ink according to this embodiment, the content of the triethylene glycol monobutyl ether d is 6 mass % or less in order to avoid deterioration of adhesion and rubfastness due to high solubility and deterioration of ejection stability due to low viscosity.

### (Water)

In the ink according to this embodiment, ion exchanged water, purified water, distilled water, or the like can be used as water. In the ink according to this embodiment, the content of water is favorably 40 mass % or more and 80 mass % or less from the viewpoints of dryness and ejection reliability.

### (Other Components)

In the ink according to this embodiment, components other than the above may be blended as necessary. For example, it is favorable to blend a surfactant in the ink according to this embodiment. As the surfactant blended in the ink according to this embodiment, a silicone surfactant is favorable. In the ink according to this embodiment, by blending a silicone surfactant, it is possible to improve wet-spreadability on the surface of the non-permeable medium. The silicone surfactant is a surfactant having a siloxane bond in its molecule. Examples of the commercial product of the silicone surfactant include SILFACE (registered trademark) SAG002 and SILFACE SAG503A manufactured by Nissin Chemical Co., Ltd.

Further, in the ink according to this embodiment, a dispersant having the effect of enhancing the dispersibility of the pigment a in the solvent may be blended. As the dispersant, a pigment dispersion resin or the like can be used. The pigment dispersion resin is fine particles of a resin that is water-soluble and constitutes a pigment dispersion together with the pigment a by adhering to the surface of the pigment a to suppress the agglomeration of the pigment a. Examples of the pigment dispersion resin include a copolymer of at least one monomer selected from the group consisting of (meth)acrylic acid alkyl ester, styrene, and vinylnaphthalene and at least one monomer selected from the group consisting of (meth)acrylic acid and maleic acid.

As the pigment dispersion resin, a resin having a repeating unit derived from (meth)acrylic acid ((meth)acrylic acid unit), a repeating unit derived from (meth)acrylic acid alkylester ((meth)acrylic acid alkylester unit), and a styrene unit is favorable. In this case, the ratio of the (meth)acrylic acid unit to all repeating units of the pigment dispersion resin is favorably 4.5 mass % or more and 8.0 mass % or less. The ratio of the (meth)acrylic acid alkylester unit to all repeating units of the pigment dispersion resin is favorably 35 mass % or more and 70 mass % or less. The ratio of the styrene unit to all repeating units of the pigment dispersion resin is favorably 27 mass % or more and 60 mass % or less. As the pigment dispersion resin, a resin having a repeating unit derived from methacrylic acid, a repeating unit derived from methyl methacrylate, a repeating unit derived from butyl acrylate, and a styrene unit is more favorable.

In the ink according to this embodiment, the content of the pigment dispersion resin is favorably 0.5 mass % or more and 8.0 mass % or less, more favorably 1.5 mass % or more and 4.0 mass % or less. By setting the content of the pigment dispersion resin to 0.5 mass % or more, it is possible to more effectively suppress the agglomeration of the pigment a. By setting the content of the pigment dispersion resin to 8.0 mass % or less, it is possible to suppress the occurrence of nozzle clogging of the recording head.

Further, in addition to the surfactant and the pigment dispersion resin, various additives such as a dissolution stabilizer, an antioxidant, a viscosity adjustor, a pH adjuster, and a neutralizer may be blended in the ink according to this embodiment as necessary.

### EXAMPLES AND COMPARATIVE EXAMPLES

As Examples and Comparative Examples of the present disclosure, inks were prepared and evaluated.

### (Preparation of Ink)

First, a pigment dispersion liquid including the pigment a dispersed in water was prepared. The pigment dispersion liquid was prepared by wet dispersing the pigment a, the pigment dispersion resin, and water using a media-type wet disperser. In the wet dispersing using a media-type wet disperser, for example, small beads (e.g., beads having D50 of 0.5 mm or more and 1.0 mm or less) can be used as media. The material of the beads is not particularly limited, but a hard material (e.g., glass and zirconia) is favorable.

In all of the inks according to Examples and Comparative Examples, carbon black was used as the pigment a, a styrene-acrylic resin was used as the pigment dispersion resin, and ion exchanged water was used as water. Further, in all of the inks according to Examples and Comparative Examples, the content of the pigment a was set to 3 mass %, the content of the pigment dispersion resin was set to 1.5 mass %, and the remainder was water.

Next, inks according to Examples and Comparative Examples were prepared. In the respective inks according to Examples and Comparative Examples, one of urethane resins b1, b2, b3, b4, b5, and b6 shown in Table 1 was used as the urethane resin b, and one of polyethylene waxes c1, c2, and c3 shown in Table 2 was used as the polyethylene wax c. The inks according to Examples and Comparative Examples were prepared by blending the urethane resin b, the polyethylene wax c, the pigment dispersion liquid, propylene glycol, the triethylene glycol monobutyl ether d, SILFACE SAG503A, and water. In all of the inks according to Examples and Comparative Examples, ion exchanged water was used as water.

TABLE 1

| Urethane resin | Breaking elongation (%) | D50(nm) | Tg(° C.) |
|---|---|---|---|
| b1 | 4 | 30 | 78 |
| b2 | 5 | 30 | 46 |
| b3 | 330 | 30 | 40 |
| b4 | 290 | 10 | −10 |
| b5 | 87 | 20 | 72 |
| b6 | 3 | 20 | 36 |

TABLE 2

| Polyethylene wax | Melting point (° C.) |
|---|---|
| c1 | 138 |
| c2 | 100 |
| c3 | 81 |

### (Evaluation of Ink)

For Examples and Comparative Examples, the adhesion of the image, the rubfastness of the image, and the ejection stability of the ink were evaluated.

### Method of Evaluating Adhesion of Image

In the evaluation of the adhesion of the image, first, a solid image was formed by ejecting the ink after applying a pre-treatment liquid to a non-permeable medium. As non-permeable media, a corona-treated polyethylene terephthalate (PET) film and a corona-treated biaxially oriented polypropylene (OPP) film manufactured by FUTAMURA CHEMICAL CO., LTD. were used. A tape (Cellulose Tape (registered trademark) manufactured by NICHIBAN Co., Ltd., a width of 18 mm, CT-18S) was applied to the solid image formed on the non-permeable medium, the surface state of the solid image after peeling off the tape was observed, and the ratio of the area of the region where the image was peeled off to the area of all regions where the tape was applied in the solid image was measured. The obtained measured value was used as an evaluation value for the adhesion of the image. Using the evaluation value for the adhesion of the image, evaluation was performed in the following criteria A to C. Inks with the evaluation of A for the adhesion of the solid image are evaluated to “Pass”, and inks with the evaluation of B or C are evaluated to “Fail”.
A: less than 10%
B: 10% or more and less than 50%
C: 50% or more.

### Method of Evaluating Rubfastness of Image

The rubfastness of the image was evaluated in accordance with JIS L 0849, using a load of 200 g and cotton (cotton cloth) for a friction cloth, and the number of times of reciprocation was set to 100. In the evaluation of the rubfastness of the image, first, a solid image having a WET film thickness of approximately 6 μm was formed on a non-permeable medium to which each pre-treatment liquid was applied, using each ink and a bar coater (“K303S multicoater” manufactured by Matsuo Sangyo Co., Ltd.) with the bar number 1. As non-permeable media, a corona-treated polyethylene terephthalate (PET) film and a corona-treated biaxially oriented polypropylene (OPP) film manufactured by FUTAMURA CHEMICAL CO., LTD. were used. The solid image formed on the non-permeable medium was dried at 100° C. for 10 minutes and allowed to stand in the atmosphere for half a day, and then, a solid image rubfastness test was carried out using a Gakushin-type rubbing tester. The solid image after the test was visually observed, and evaluation was performed in the following criteria A to C. Inks with the evaluation of A for the rubfastness of the solid image are evaluated to “Pass”, and inks with the evaluation of B or C are evaluated to “Fail”.
A: No streaks or abrasions are observed (see a photograph A of The Figure).
B: Fewer than 10 streaks are observed (see a photograph B of The Figure).
C: 10 or more streaks are observed (see a photograph C of The Figure).

### Ejection Stability

The ejection stability of the ink was evaluated on the basis of the degree of misdirection in the non-printed portion. That is, the lower the ejection stability of the ink, the more likely for the liquid droplet tail to ripple after ejection, causing misdirection in the non-printed portion. Therefore, it can be seen that the greater the misdirection in the non-printed portion, the lower the ejection stability.

The degree of misdirection in the non-printed portion was evaluated under an environment of room temperature and high humidity (environment of a temperature of 25° C. and a humidity of 80% RH) in order to suppress the influence of the nozzle of the line head. An inkjet recording apparatus (prototype manufactured by KYOCERA Document Solutions Inc., 600 dpi) was used as an evaluation device. For this evaluation device, a pre-treatment liquid or ink was purged from the line head and the line head was wiped (purging and wiping processing). One minute after the purging and wiping processing, one horizontal line (line along the main scanning direction) was formed on A4 glossy paper (“Super Fine Paper” manufactured by Seiko Epson Corp.) using the evaluation device. At this time, the line width of the horizontal line was set to one dot (corresponding to one drop of the pre-treatment liquid or ink). The volume per dot (volume per drop) of the pre-treatment liquid or ink ejected from the individual nozzle of the line head was set to 3 pL.

Next, the misalignment amount of the above-mentioned horizontal line was determined using an optical microscope (“MM-800” manufactured by Nikon Corporation). In detail, the maximum distance (misalignment amount) in the sub-scanning direction of each dot forming the above-mentioned horizontal line was measured using application software attached to the above-mentioned optical microscope. The larger the misalignment amount, the more the above-mentioned horizontal line is distorted due to the misdirection in the non-printed portion. The misalignment amount obtained with each pre-treatment liquid or ink was used as an evaluation value for ejection stability. Using the evaluation value for the ejection stability of each pre-treatment liquid or ink, evaluation was performed in accordance with the following criteria A and B. Pre-treatment liquids or inks with the evaluation of A for ejection stability are evaluated to “Pass”, and pre-treatment liquids or inks with the evaluation of B are evaluated to “Fail”.
A: 20 μm or less
B: exceeding 20 μm

### Examples 1 to 9

In Examples 1 to 9, inks having the composition shown Table 3 were prepared. In Table 3, the numerical value described for each component indicates the content (mass %) of each component. The inks according to Examples 1 to 9 have the configuration of the ink according to the above embodiment.

TABLE 3

| | | Example | | | | | | | | |
|---|---|---|---|---|---|---|---|---|---|---|
| Component | | 1 | 2 | 3 | 4 | 5 | 6 | 7 | 8 | 9 |
| Urethane resin | b1 | 5 | 5 | 5 | 3 | 8 | 5 | | 5 | 5 |
| | b2 | | | | | | | 5 | | |
| Polyethylene wax | c1 | 3 | 2 | 5 | 3 | 3 | | 3 | 3 | 3 |
| | c2 | | | | | | 3 | | | |

| | | | | | | | | | |
|---|---|---|---|---|---|---|---|---|---|
| Pigment dispersion | 5 | 5 | 5 | 5 | 5 | 5 | 5 | 5 | 5 |
| Propylene glycol | 20 | 20 | 20 | 20 | 20 | 20 | 20 | 20 | 20 |
| Triethylene glycol | 5 | 5 | 5 | 5 | 5 | 5 | 5 | 3 | 6 |
| monobutyl ether | | | | | | | | | |
| SILFACE SAG503A | 0.3 | 0.3 | 0.3 | 0.3 | 0.3 | 0.3 | 0.3 | 0.3 | 0.3 |
| Water | 61.7 | 62.7 | 59.7 | 63.7 | 58.7 | 61.7 | 61.7 | 63.7 | 60.7 |

Table 4 shows the evaluation results of the adhesion of the image, the rubfastness of the image, and the ejection stability for the inks according to Examples 1 to 9. As shown in Table 4, in all of the inks according to Examples 1 to 9, the adhesion of the image, the rubfastness of the image, and the ejection stability of the ink were evaluated to “Pass”.

TABLE 4

| | | Example | | | | | | | | |
|---|---|---|---|---|---|---|---|---|---|---|
| Component | | 1 | 2 | 3 | 4 | 5 | 6 | 7 | 8 | 9 |
| Adhesion (PET) | | A | A | A | A | A | A | A | A | A |
| Adhesion (OPP) | | A | A | A | A | A | A | A | A | A |
| Rubfastness (PET) | | A | A | A | A | A | A | A | A | A |
| Rubfastness (OPP) | | A | A | A | A | A | A | A | A | A |
| Ejection | Evaluation value (μm) | 19 | 20 | 19 | 18 | 20 | 16 | 20 | 19 | 20 |
| stability | Evaluation | A | A | A | A | A | A | A | A | A |

### Comparative Examples 1 to 8

In Comparative Examples 1 to 8, inks having the composition shown in Table 5 were prepared. In Table 5, the numerical value described for each component indicates the content (mass %) of each component. The ink according to Comparative Example 1 is different from the ink according to the above embodiment in that the content of the triethylene glycol monobutyl ether d is low. The ink according to Comparative Example 2 is different from the ink according to the above embodiment in that the content of the triethylene glycol monobutyl ether d is high. The inks according to Comparative Examples 3 to 5 are different from the ink according to the above embodiment in that the urethane resin b has a high breaking elongation. The inks according to Comparative Examples 4 and 6 are different from the ink according to the above embodiment in that the urethane resin b has a low glass transition temperature Tg. The ink according to Comparative Example 7 is different from the ink according to the above embodiment in that dipropylene glycol methyl ether is used instead of the triethylene glycol monobutyl ether d. The ink according to Comparative Example 8 is different from the ink according to the above embodiment in that the polyethylene wax c has a low melting point.

TABLE 5

| | | Comparative Example | | | | | | | |
|---|---|---|---|---|---|---|---|---|---|
| Component | | 1 | 2 | 3 | 4 | 5 | 6 | 7 | 8 |
| Urethane resin | b1 | 5 | 5 | | | | | 5 | 5 |
| | b3 | | | 5 | | | | | |
| | b4 | | | | 5 | | | | |
| | b5 | | | | | 5 | | | |
| | b6 | | | | | | 5 | | |
| Polyethylene wax | c1 | 3 | 3 | 3 | 3 | 3 | 3 | 3 | |
| | c3 | | | | | | | | 3 |

| | | | | | | | | |
|---|---|---|---|---|---|---|---|---|
| Pigment dispersion | 5 | 5 | 5 | 5 | 5 | 5 | 5 | 5 |
| Propylene glycol | 20 | 20 | 20 | 20 | 20 | 20 | 20 | 20 |
| Triethylene glycol | 1 | 8 | 5 | 5 | 5 | 5 | | 5 |
| monobutyl ether | | | | | | | | |
| Dipropylene glycol | | | | | | | 5 | |
| methyl ether | | | | | | | | |
| SILFACE SAG503A | 0.3 | 0.3 | 0.3 | 0.3 | 0.3 | 0.3 | 0.3 | 0.3 |
| Water | 65.7 | 58.7 | 61.7 | 61.7 | 61.7 | 61.7 | 61.7 | 61.7 |

Table 6 shows the evaluation results of the adhesion of the image, the rubfastness of the image, and the ejection stability for the inks according to Comparative Examples 1 to 8. As shown in Table 6, in all of the inks according to Comparative Examples 1 to 8, at least one of the adhesion of the image, the rubfastness of the image, or the ejection stability of the ink was evaluated to “Fail”.

TABLE 6

| | | Comparative Example | | | | | | | |
|---|---|---|---|---|---|---|---|---|---|
| Component | | 1 | 2 | 3 | 4 | 5 | 6 | 7 | 8 |
| Adhesion (PET) | | B | A | A | A | A | A | C | A |
| Adhesion (OPP) | | C | B | A | A | A | A | C | A |
| Rubfastness (PET) | | C | A | C | C | B | A | C | B |
| Rubfastness (OPP) | | C | B | C | C | C | A | C | C |
| Ejection | Evaluation value (μm) | 15 | 26 | 26 | 30 | 19 | 23 | 18 | 18 |
| stability | Evaluation | A | B | B | B | A | B | A | A |

It should be understood by those skilled in the art that various modifications, combinations, sub-combinations and alterations may occur depending on design requirements and other factors insofar as they are within the scope of the appended claims or the equivalents thereof.

What is claimed is:

1. A water-based ink for non-permeable media, comprising:
a pigment;
a urethane resin having a glass transition temperature of 40° C. or more and 110° C. or less and a breaking elongation at 25° C. of 50% or less;
a polyethylene wax having a melting point of 100° C. or more and 140° C. or less;
triethylene glycol monobutyl ether; and
water,
a content of the urethane resin being 3 mass % or more and 8 mass % or less in terms of solid content,
a content of the polyethylene wax being 2 mass % or more and 5 mass % or less in terms of solid content, and
a content of the triethylene glycol monobutyl ether being 3 mass % or more and 6 mass % or less.

2. The water-based ink for non-permeable media according to claim 1, wherein the water-based ink is used for surface printing.
